(19) United States
(12) Patent Application Publication
(10) Pub. No.: US 2011/0178725 A1
(43) Pub. Date: Jul. 21, 2011

(54) METHOD OF ASSISTING DECISION-TAKING CONCERNING THE AIRWORTHINESS OF AN AIRCRAFT

(75) Inventor: Catherine BUCHHEIT, L'Isle Jourdain (FR)

(73) Assignee: AIRBUS, Blagnac (FR)

(21) Appl. No.: 13/005,987

(22) Filed: Jan. 13, 2011

(30) Foreign Application Priority Data
Jan. 20, 2010 (FR) 1050356

(51) Int. Cl. G06F 19/00

(52) U.S. Cl. 702/35

(57) ABSTRACT

The aircraft includes
at least one sensor permanently fastened to the aircraft and suitable, while the aircraft is in use, for providing data relating to at least one instantaneous size of at least one crack; and
means suitable for acting as a function of the data to determine information concerning the airworthiness of the aircraft.

### FIELD OF THE INVENTION

The invention relates to analyzing the airworthiness of an aircraft.

### BACKGROUND OF THE INVENTION

When a crack is discovered in an aircraft, appropriate measures need to be taken to allow it to fly again. For example, if the crack is in a secondary structure of a pylon, the intervention consists in cutting away the zone that has the crack and in installing a metal patch to replace the portion that has been cut away. It is also necessary to perform an inspection operation in order to guarantee the soundness of the repaired structure. The aircraft is thus grounded throughout the time needed for this to be done. The consequences of discovering a crack are thus relatively expensive for the airline.

### OBJECT AND SUMMARY OF THE INVENTION

An object of the invention is to lighten the consequences for the airline of discovering a crack.

To this end, the invention provides an aircraft that includes:
at least one sensor permanently fastened to the aircraft and suitable, while the aircraft is in use, for providing data relating to at least one instantaneous size of at least one crack; and
means suitable for acting as a function of the data to determine information concerning the airworthiness of the aircraft.

Thus, the sensor enables an immediate analysis to be performed concerning the airworthiness of the aircraft. It enables variation of the crack to be monitored actively and continuously and it enables any propagation thereof to be detected. The invention thus makes it possible to eliminate all or some of the manual crack-inspection operations and to put off repairing the crack if such repair is not essential and the aircraft is capable of continuing to perform a certain number of cycles without risk.

The invention enables variation of a crack to be detected before it has propagated to such an extent as to make it necessary for the aircraft to be grounded. By virtue of this anticipation, it is possible at an early stage, and if necessary, to implement repair operations in a manner that makes them compatible with the normal operations that are performed while the aircraft is on the ground, without it being necessary for the aircraft to be grounded for a long time.

The invention thus provides assistance in decision-taking when a crack is present and is possibly propagating. The invention makes it possible to anticipate the arrival of a failure and to track the propagation of the crack. The invention provides both a diagnosis and a prognosis. The invention makes it possible to perform detection and anticipation on structural portions of an airplane that would otherwise normally require a lengthy inspection task because they are poorly accessible, e.g. when they require disassembly and assembly operations.

In other words, the invention makes it possible not only to detect that a crack presents a certain length, but above all, and where appropriate, to allow the aircraft to continue flying before optionally initiating repair work, and to continue doing this until the crack has reached a predetermined length. Once the crack has reached said length, the airplane may be grounded in order to perform the necessary repair operations. These operations are thus performed at a convenient moment without it being necessary to ground the airplane pointlessly and prematurely.

In this embodiment, the data processing in order to obtain the diagnosis about the airworthiness of the airplane is performed mainly on board the airplane.

The invention also provides an aircraft that includes:
at least one sensor permanently fastened to the aircraft and suitable, while the aircraft is in use, for providing data relating to at least one instantaneous size of at least one crack; and
means suitable for transmitting the data from the sensor and/or a result of processing said data remotely from the aircraft.

In this embodiment, the data processing in order to obtain a diagnosis concerning the airworthiness of the airplane is performed remotely from the airplane, e.g. on the ground.

In an embodiment, the sensor comprises conductors connected in a parallel configuration and arranged in such a manner that each conductor is suitable for breaking when the size of the crack or one of the cracks crosses a predetermined threshold specific to the conductor, the respective thresholds associated with the conductors differing from one another.

It is thus easy to determine whether all of the conductors are intact, such that the size(s) of the crack(s) has/have varied little, or on the contrary that at least one of the conductors has broken, thus indicating that the size of the or one of the cracks has varied significantly.

For example, provision may be made for the conductors to present respective impedances that are different from one another.

It is thus easy to detect by calculation, and in particular remotely, which conductor has broken and thus to deduce therefrom what minimum size has been reached by the crack(s), or indeed which one of the monitored crack(s) has increased in size.

Advantageously, the impedances form a geometric series.

It is easy to make a sensor with such impedances.

It is also possible to provide for the conductors to present respective impedances that are identical.

The invention also provides an aircraft including means suitable for:
receiving from a remote transmitter, data relating to at least one instantaneous size of at least one crack of the aircraft; and
acting as a function of the data to determine information about the airworthiness of the aircraft.

The invention also provides a device for analyzing the airworthiness of an aircraft, the device comprising means suitable for:
receiving from a remote transmitter, data relating to at least one instantaneous size of at least one crack of the aircraft; and
acting as a function of the data to determine information about the airworthiness of the aircraft.

Such a device may be used, e.g. on the ground and remotely from the aircraft, to process data received from the aircraft in order to determine its airworthiness.

The invention also provides a member for monitoring at least one crack of an aircraft, the member comprising:
at least one sensor suitable for providing data relating to at least one instantaneous size of at least one crack;
fastener means for fastening the sensor permanently to an aircraft; and
means suitable for acting as a function of the data to determine information about the airworthiness of the aircraft.

The member thus specifically comprises a sensor that is itself provided with means for processing data and for providing a diagnosis about the airworthiness of the aircraft.

Advantageously, the sensor is arranged so that an impedance of the sensor varies as the size of the crack increases.

Preferably, the sensor presents zones that are suitable for breaking when the size of the crack increases.

Advantageously, the sensor is suitable for detecting a partial interruption in the fastening of the sensor to the aircraft.

Thus, not only does the sensor enable variation of a crack to be tracked, but it also makes it possible to detect a potential failure of the sensor itself. It is thus possible to monitor simultaneously variation of the crack and the integrity of the sensor.

The invention also provides an aircraft including such a sensor.

The invention also provides a method of analyzing the airworthiness of an aircraft, in which method, while the aircraft is in use:
at least one sensor permanently fastened to the aircraft delivers data relating to at least one instantaneous size of at least one crack; and
means acting as a function of the data determine information about the airworthiness of the aircraft.

The invention also provides a method of analyzing the airworthiness of an aircraft, in which method, while the aircraft is in use:
at least one sensor permanently fastened to the aircraft delivers data relating to at least one instantaneous size of at least one crack; and
means transmit the data from the sensor and/or a result of processing said data remotely from the aircraft.

The invention also provides a method of analyzing the airworthiness of an aircraft, in which method, while the aircraft is in use, means:
receive from a remote transmitter, data relating to at least one instantaneous size of at least one crack of the aircraft; and
act as a function of the data to determine information about the airworthiness of the aircraft.

The above-mentioned utilization circumstances may be constituted in particular by periods during which the aircraft is moving, in particular taxiing or flying. The method of the invention may thus be implemented while the airplane is taxiing or while it is flying.

By way of example, the crack may be located in a pylon or a pylon attachment.

The invention also provides a computer program including code instructions suitable for controlling the execution of one or more of the steps of a method of the invention.

The invention also provides a storage medium including such a program in stored form.

The invention also provides making such a program available on a telecommunications network for downloading purposes.

### BRIEF DESCRIPTION OF THE DRAWING

Other characteristics and advantages of the invention appear further from the following description of several embodiments given as non-limiting examples with reference to the accompanying drawing, in which:

FIG. 1 is a perspective view of an airplane of the invention;

FIG. 2 is a diagram of a sensor of the invention together with diagnosis means for evaluating the airworthiness of the FIG. 1 airplane;

FIG. 3 is a simplified electrical circuit diagram of a portion of the FIG. 2 sensor;

FIG. 4 is a simplified version of the FIG. 3 diagram; and

FIG. 5 is another diagram of a portion of the FIG. 2 sensor.

### MORE DETAILED DESCRIPTION

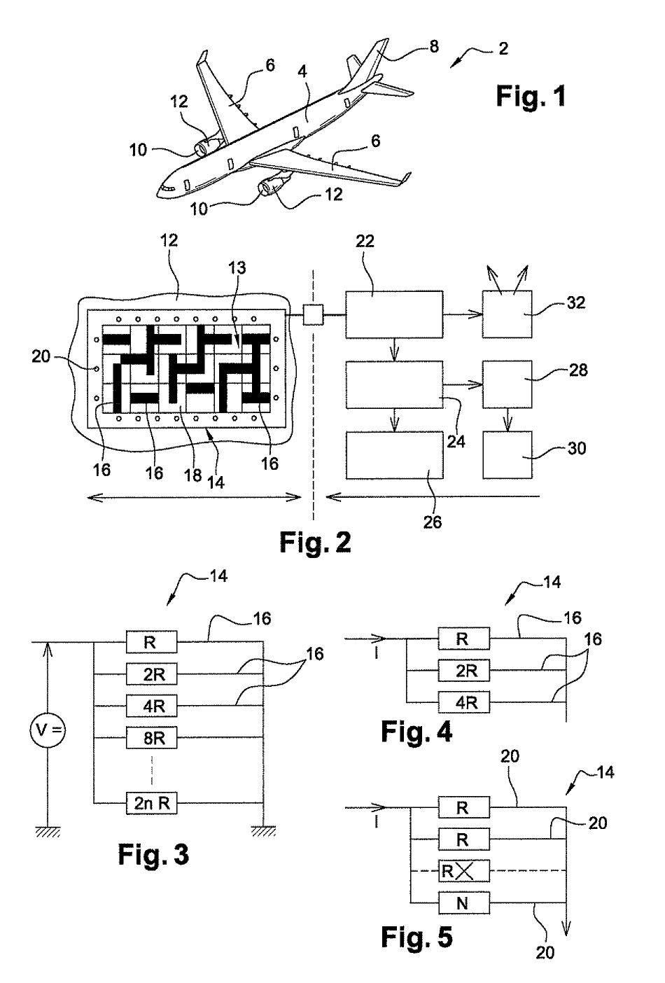

FIG. 1 shows an aircraft 2 of the invention. Specifically it is an aerodyne, and in particular an airplane. Nevertheless, the invention is also applicable to rotary wing aircraft.

The airplane 2 specifically comprises a fuselage 4, two wings 6, a tail 8, and jets 10, two jets in this example that are fastened to the insides of respective ones of the wings 6 by means of respective pylons 12.

In the present example, the invention is applied to monitoring cracks that might appear in the primary and secondary structures of the pylons 12. Nevertheless, the invention is not restricted to such an application and it may concern other structural portions of the airplane.

Each of the pylons 12 in this example includes one or more sensors 14 such as the sensor shown in FIG. 2. The sensor 14 is permanently fastened to a structural portion of the pylon that is to be monitored. In this example, the sensor is of the wire break type. A sensor of this type is itself known, e.g. from document U.S. Pat. No. 4,255,974. The sensor 14 is fastened to a zone 13 of the pylon that is identified as a crack-precursor location. By way of example, it might be a fold zone, a rivet hole, etc.

Specifically, the sensor 14 comprises a plurality of electrically conductive wires 16 that are appropriately connected together in parallel. At least some of the wires 16 are also folded or curved so as to present a plurality of segments that are not in mutual alignment. The wires 16 and/or their segments are disposed in such a manner as to monitor the entire zone 13 in which one or more cracks might propagate. Preferably, the wires and/or wire segments are disposed in such a manner that each portion 18 of the zone 13 is monitored by at least two wires or two segments. If a portion of the zone is not appropriately monitored by at least one of the wires or at least one of the segments, there would be danger of not detecting the appearance of a crack or changes in the size of a crack. As can be seen in FIG. 2, each portion 18 of the monitored zone is associated with at least one segment of wire 16. The portions 18 in this example are obtained by notionally subdividing the zone for monitoring into rows and columns, and each portion is square in shape. This constitutes a matrix configuration. The wires themselves are in a matrix arrangement. Nevertheless, this is merely one example of how the wires may be arranged. Depending on what can be expected about the appearance of cracks and their preferred propagation directions, other configurations may be selected such as a mosaic, circular, random, type configuration. The pattern of the configuration of the wires is thus selected depending on circumstances.

By having the wires 16 in such a configuration, should a crack propagate through the zone 13, it will break at least one of the wires. The set of wires 16 forms a multiple-branch conductor, which conductor presents an overall impedance. One of its wires breaking leads to said impedance being changed, thus making it possible to detect the break and identify which wire has broken. Where appropriate, it is thus also possible to deduce that the monitored crack has reached a certain length.

The sensor 14 is fastened to the structure 12, e.g. by means of an adhesive such as a sol-gel type adhesive that enables the fastening to withstand high temperatures, here in the zone of the pylon 12. The adhesive also enables the adhesively-bonded zone to be inspected visually, given that the adhesive is constituted by a transparent gel. It is thus possible to verify the general state of the sensor visually and to cover the mitigation aspects that are required by certification.

The sensor 14 in this example also includes conductors in the form of spots 20 that are fastened to the zone 13 and that are connected to the remainder of the sensor. Should the sensor 14 become partially unstuck from the zone 13 by becoming separated at one of these spots, electrical conduction between the spot and the remainder of the sensor is interrupted. As above, the conductors forming the spots are connected so as to present predetermined impedance. In the event of one of the spots breaking, the change in the impedance makes it possible to detect damage to the fastening of the sensor to the zone. Preferably, each of the spots 20 is located at a position that presents little likelihood of coming into contact with the failure being monitored.

The sensor 14 also includes a voltage generator enabling the terminals of the sensor to be subjected to an electrical voltage, and also, where appropriate, making it possible to detect a change of impedance, as mentioned above.

The impedance change enables the sensor to provide data, in particular concerning the magnitude of the electric current flowing through the sensor, and an analysis thereof enables the airworthiness of the airplane to be diagnosed. Various diagnosis implementations are described below.

In a first implementation, all of the analysis is performed on the ground. Equipment 22 serves to receive a current value measured flowing through the sensor 14 in order to deduce the impedance value therefrom, the voltage V across the terminals of the sensor being known. The data as obtained in this way is transmitted to a diagnosis device 24 which analyses it in order to obtain a value that constitutes an estimate of the length of the crack. This value is compared with predetermined threshold values. The equipment 24 converts the result of this analysis into simple language in order to enable an operating decision to be taken quickly, and for this purpose the result is transmitted to a man-machine interface 26 where it is displayed for viewing by a human operator. By way of example, the display may give the number of cycles that the airplane is still capable of performing. The devices 22, 24, and 26 are on the ground and they are independent of the airplane. An advantage of this solution is that it is independent of the architecture of the airplane, and in particular of its computer processor means. In contrast, it requires a tool to be managed on the ground, both in terms of operations and of hardware.

In a second implementation, the pieces of equipment 22 and 24 form parts of the airplane. By way of example they may be computers of the engine system. The data is analyzed and processed in the same manner as in the first implementation by the equipment 24, but this is now done on board, and then the result thereof is delivered via the communications bus of the airplane to a data centralizer such as that performing the aircraft conditioning monitoring function (ACMF). The centralizer 28 transmits the diagnosis as made in this way to the ground, in the form of a data report. The diagnosis is transmitted by the flight/ground communications means to a ground station 30 where it is analyzed by an operator who can decide whether or not to carry out a repair operation and who can also make a decision concerning the airworthiness of the aircraft. An advantage of this embodiment is that it is fully automated up to the arrival of the diagnosis at the station 30. It does not require any additional maintenance tool.

In a third implementation, the on-board sensor 14 itself includes the acquisition equipment 22 and an analyzer member 32 suitable for making a diagnosis about the airworthiness of the aircraft. Thus, the sensor and the diagnosis are integrated and made independent from an analysis point of view. Provision may also be made for the sensor to be made independent from an electrical point of view by providing the sensor with its own storage battery. Once the diagnosis has been performed by the equipment 32, it is transmitted to the ground as in the second implementation. This transmission may take place via high frequency wireless transmission means. An advantage of this implementation is that no use is made of the airplane computers, thus making it possible, should that be necessary, to deploy a large number of sensors without overloading the computers while performing processing operations.

As mentioned above, the method of the invention analyzes the variation in the impedance of the sensor that results from a wire 16 breaking due to a crack passing under the wire.

By way of example, the table below has three columns showing respectively:
the range of values in which the length L of the crack as detected lies;
the diagnosis that is drawn therefrom by the analysis means; and
the resulting display on the man-machine interface.

| Detected length | Diagnosis | Display on interface |
|---|---|---|
| L < 10 mm | No limit on cycles | “GO” |
| 10 mm < L < 20 mm | Number of cycles limited | “GO” - compatible |
| | to 2000 | with 2000 cycles |
| 20 mm < L < 40 mm | Number of cycles limited | “GO” - compatible |
| | to 1000 | with 1000 cycles |
| 40 mm < L < 60 mm | Number of cycles limited | “GO” - compatible |
| | to 500 | with 500 cycles |
| 60 mm < L < 100 mm | “No GO” - repair | No new cycle, |
| | | i.e. “No GO” |

FIG. 3 is a simplified electrical circuit diagram of the sensor 14 showing its various branches 16 formed by the wires. Here the resistances of the branches are selected so that they are all different from one another and making it possible, where appropriate, and as a function of the newly-measured impedance, to identify which ones of the branches have been broken. In this example, the respective branches present resistances that form a geometric series of the type R, 2R, 4R, 8R, . . . , 2ⁿR. Such a selection enables the broken branch to be identified easily.

FIG. 4 thus constitutes a simplified diagram having only three branches 16 associated with respective resistances R, 2R, and 4R. If none of the branches is disconnected, then the current I flowing through the sensor is calculated as follows:

I=V/R+V/2R+V/4R=7V/4R

If a single branch is disconnected, then the following calculations apply depending on the circumstances:

I=V/R+V/2R or V/2R+V/4R or V/R+V/4R

i.e, I=6V/4R or 3V/4R or 5V/4R

If two branches are disconnected, the three possible configurations are as follows:

I=4V/4R or 2V/4R or V/4R

Finally, if all three branches are disconnected, the current is zero.

The table below summarizes these various configurations.

| I (current) | Faulty branches |
|---|---|
| 7 V/4R | 0 |
| 6 V/4R | No. 3 |
| 5 V/4R | No. 2 |
| 4 V/4R | No. 2 + No. 3 |
| 3 V/4R | No. 1 |
| 2 V/4R | No. 1 + No. 3 |
| 1 V/4R | No. 1 + No. 2 |
| 0 | No. 1 + No. 2 + No. 3 |

With reference to FIG. 5, the same method serves to identify whether one of the spots 20 has been broken. Specifically, each of these spots 20 presents the same resistance R, with the spots 20 forming an array of parallel-connected branches.

If all of the spots are intact, with the sensor properly fastened to the zone 12, the voltage V and the current I satisfy the formula:

V=n×R×I

In contrast, if one of the branches is broken, the formula becomes:

V=(n−1)×R×I

The above-described automatic means used for implementing the method of the invention comprise in particular computer processor means having one or more microprocessors, one or more memories, and means for receiving and transmitting data, possibly wirelessly. These means include, in stored form, one or more computer programs suitable for controlling the execution of one or more of the steps of the method of the invention when executed on one of said means. Provision may be made to store the program on a data storage medium, or indeed to make it available on a telecommunications network in order to be downloaded, e.g. for downloading updated versions.

The method of the invention is preferably implemented continuously or periodically while the airplane is in use, and in particular while it is in flight, or indeed while it is taxiing on the ground prior to takeoff or after landing.

The invention enables portions of the pylon to be monitored actively, in particular any metal portions thereof, in order to detect an incipient crack or crack propagation. It makes it possible to identify or to estimate the length of the crack in order to deduce therefrom the residual capacity of the cracked zone, in terms of cycles. It makes it possible to anticipate a possible maintenance action. The invention provides greater independence in the decision-taking that is left to the airline concerning the lengths of the cracks and their propagation. In particular, the invention makes it possible to avoid always grounding an airplane whenever a crack is detected. It can be seen in particular that under certain circumstances the invention makes it possible to authorize the airplane to fly for a certain number of cycles even if a crack has been detected and it is in the process of propagating, given that the analysis has shown that those cycles may be flown without danger.

The invention serves to reduce the number of assembly and disassembly operations that are needed to access and view a potentially-cracked zone and, where appropriate, to monitor the propagation of a detected crack. The invention makes it possible to make a diagnosis about the existence and the propagation of cracks, including in zones that are not easily accessible.

The invention may be implemented in an automatic system architecture in the context of in-flight integration.

Naturally, numerous modifications may be made to the invention without going beyond the ambit thereof.

The impedance values of the sensor may be selected in such a manner as to form a geometric series other than that described above, e.g. a series of the type R, 3R, 9R, 27R, . . . , 3ⁿR. Provision may also be made for the values to be different from one another so as to enable the or each broken branch to be identified by calculation without the values constituting a geometric series.

What is claimed is:

1. An aircraft, including:
at least one sensor permanently fastened to the aircraft and suitable, while the aircraft is in use, for providing data relating to at least one instantaneous size of at least one crack; and
means suitable for acting as a function of the data to determine information concerning the airworthiness of the aircraft.

2. An aircraft, including:
at least one sensor permanently fastened to the aircraft and suitable, while the aircraft is in use, for providing data relating to at least one instantaneous size of at least one crack; and
means suitable for transmitting remotely from the aircraft the data from the sensor and/or a result of processing said data.

3. An aircraft according to claim 1, wherein the sensor comprises conductors connected in a parallel configuration, presenting respective impedances that are different from one another and arranged in such a manner that each conductor is suitable for breaking when the size of the crack or one of the cracks crosses a predetermined threshold specific to the conductor, the respective thresholds associated with the conductors differing from one another.

4. An aircraft according to claim 3, wherein the impedances form a geometric series.

5. An aircraft according to claim 1, wherein the sensor is suitable for detecting partial interruption of the fastening of the sensor to the aircraft.

6. An aircraft, including means suitable for:
receiving from a remote transmitter, data relating to at least one instantaneous size of at least one crack of the aircraft; and
acting as a function of the data to determine information about the airworthiness of the aircraft.

7. A method of analyzing the airworthiness of an aircraft, wherein, while the aircraft is in use:
at least one sensor permanently fastened to the aircraft delivers data relating to at least one instantaneous size of at least one crack; and
means acting as a function of the data determine information about the airworthiness of the aircraft.

8. A method of analyzing the airworthiness of an aircraft, wherein, while the aircraft is in use:
at least one sensor permanently fastened to the aircraft delivers data relating to at least one instantaneous size of at least one crack; and
means transmit remotely from the aircraft the data from the sensor and/or a result of processing said data.

9. A method of analyzing the airworthiness of an aircraft, wherein, while the aircraft is in use, means:
receive from a remote transmitter, data relating to at least one instantaneous size of at least one crack of the aircraft; and
act as a function of the data to determine information about the airworthiness of the aircraft.

10. A method according to claim 7, implemented while the aircraft is in flight.

11. A method according to claim 7, implemented while the aircraft is taxiing.

12. An aircraft according to claim 2, wherein the sensor comprises conductors connected in a parallel configuration, presenting respective impedances that are different from one another and arranged in such a manner that each conductor is suitable for breaking when the size of the crack or one of the cracks crosses a predetermined threshold specific to the conductor, the respective thresholds associated with the conductors differing from one another.

13. An aircraft according to claim 12, wherein the impedances form a geometric series.

14. An aircraft according to claim 2, wherein the sensor is suitable for detecting partial interruption of the fastening of the sensor to the aircraft.

15. A method according to claim 8, implemented while the aircraft is in flight.

16. A method according to claim 9, implemented while the aircraft is in flight.

17. A method according to claim 8, implemented while the aircraft is taxiing.

18. A method according to claim 9, implemented while the aircraft is taxiing.
